(19) United States
(12) Patent Application Publication
(10) Pub. No.: US 2025/0112518 A1
(43) Pub. Date: Apr. 3, 2025

(54) ELECTRIC MOWER AND MOWING DECK MOTOR ASSEMBLY

(71) Applicant: Hydro-Gear Limited Partnership, Sullivan, IL (US)

(72) Inventors: Nathan W. Bonny, Shelbyville, IL (US); Michael L. Bennett, Sullivan, IL (US); Ryan S. Buescher, Neoga, IL (US); Shane A. Deters, Charleston, IL (US)

(21) Appl. No.: 18/900,385

(22) Filed: Sep. 27, 2024

Related U.S. Application Data
(60) Provisional application No. 63/586,919, filed on Sep. 29, 2023.

(51) Int. Cl. H02K 5/15; A01D 34/66; A01D 34/78; A01D 69/02; A01D 101/00; H02K 5/10; H02K 5/22

(52) U.S. Cl. CPC H02K 5/15; A01D 34/78; A01D 69/02; H02K 5/10; H02K 5/225; A01D 34/66; A01D 2101/00; H02K 2205/09

(57) ABSTRACT

A utility vehicle such as a lawn mower includes a deck having one or more electric deck motor assemblies mounted thereon. Each deck motor assembly includes an electric motor compartment formed by combining a motor end cap, a stator housing and a motor output cap. The motor end cap forms a flat motor mounting surface that seats around the perimeter of an opening in the deck such that the stator housing and motor output cap extend through the opening. The motor compartment contains an electric motor that drives a motor shaft connected to a mowing blade suspended below the deck. Rotation of the mowing blade air-cools the components of the motor compartment that extend through the opening in the deck. The deck motor assembly may include a debris shield for protection of a motor output shaft lower bearing seal during operation and cleaning of the mowing deck.

### CROSS-REFERENCE

This application claims priority to U.S. Provisional Application No. 63/586,919, filed on Sep. 29, 2023, the contents of which are incorporated herein by reference in their entirety.

### BACKGROUND

This application relates to an electric motor assembly optimized for use on a mowing deck of an electrically powered mowing vehicle, such as a zero turn-radius (ZT) lawn mower. Such an electric motor assembly may also be used in other applications.

### SUMMARY

An electrically powered mowing vehicle utilizing one or more electric mid-mount mowing deck motor assemblies is disclosed herein. In the embodiments of the electric motor assemblies disclosed herein, motor mounting surfaces (or features, such as mounting lugs of the first embodiment) are integrally formed on an upper housing and positioned such that, when the motor is mounted on a mowing deck, a substantial portion of the electric motor is situated below the mowing deck and exposed to cooling air flow generated by the rotation of mower blades of the mowing deck during operation. The mounting surfaces have threaded holes formed therein so the deck motors can be seated on top of the mowing deck but fastened from the underside of the deck along with the mower blades for a more efficient assembly process (i.e. allowing a mower manufacturer to fasten blades and deck motors to the deck at one assembly station without flipping the deck over at that assembly station).

Deck motors on some mowing decks are mounted in recesses formed in the deck. These recesses can accumulate debris around deck motor housings. The disclosed mid-mount deck motors can eliminate the need for these deck recesses or reduce their depth, resulting in cost savings, easier fabrication of mowing decks, and improved operation and longevity of deck motors.

On a typical mowing deck that utilizes at least one electric deck motor, a mower blade is attached to an adapter mounted on the motor output shaft of each electric deck motor. Some mowing vehicle manufacturers may utilize a flat deck design but then must use elongated adapters to position the mower blades properly in relation to the ground. Use of elongated adapters causes additional stress to deck motor output shaft bearings that can shorten the service life of these bearings. The disclosed mid-mount deck motors can eliminate the need for elongated adapters in conjunction with the use of a flat mowing deck or one with shallow recesses rather than deep recesses.

During operation, mower blades and mowing deck profiles typically create an upward air flow that lifts grass (or other vegetation) for cutting and an outward air flow for expulsion of clippings through a discharge chute, etc. Because of this generally outward air flow, the underside deck surface directly above a mower blade along the axis of blade rotation receives a lesser accumulation of debris. The disclosed mid-mount deck motor configurations are designed to take advantage of this by positioning the deck motor such that a portion of it can extend below the deck mounting surface to receive relatively debris-free cooling airflow across the deck motor's housing surfaces. To achieve weight savings, and for its heat dissipation properties, a preferred material of the housing components of the disclosed motor assembly is aluminum. A first embodiment of a mid-mount deck motor assembly depicted herein includes a debris shield fitted on the motor output shaft for protecting the sealed lower bearing during motor operation and during cleaning of the underside of the mowing deck. A second embodiment of a mid-mount deck motor assembly depicted herein employs a bearing seal protection flange integrally formed on the motor output cap to fit closely around the motor output shaft so as to protect the sealed lower bearing. Each of the motor assembly embodiments described herein may be configured with or without a Hall effect board, and can include a less expensive electrical connector when configured without the Hall effect board.

A better understanding of the disclosure herein will be obtained from the following detailed description and accompanying drawings.

### BRIEF DESCRIPTION OF THE DRAWINGS

FIG. 1 is a perspective view of a first embodiment of an electric mid-mount motor assembly including a debris shield positioned adjacent to a sealed bearing supporting the motor output shaft.

FIG. 2 is an exploded perspective view of the electric motor assembly of FIG. 1.

FIG. 3 is a plan view of the electric motor assembly of FIG. 1, shown mounted on a deck mounting surface on the upper side of a mowing deck.

FIG. 4 is a cross-sectional view of the electric motor assembly of FIG. 3, along the line 4-4 in FIG. 3.

FIG. 5 is a schematic view of a representative electrically powered vehicle, including a mowing deck utilizing electric mid-mount motor assemblies of the instant disclosure.

FIG. 6 is a perspective view of a second embodiment of an electric mid-mount motor assembly.

FIG. 7 is a plan view of the electric motor assembly of FIG. 6.

FIG. 8 is a cross-sectional view of the electric motor assembly of FIG. 7, along the line 8-8 in FIG. 7.

### DETAILED DESCRIPTION OF THE DRAWINGS

The description that follows describes, illustrates and exemplifies one or more embodiments in accordance with its principles. This description is not provided to limit the disclosure to the embodiment(s) described herein, but rather to explain and teach the principles of the invention(s) disclosed herein in order to enable one of ordinary skill in the art to understand these principles and, with that understanding, be able to apply them to practice not only the embodiment(s) described herein, but also any other embodiment that may come to mind in accordance with these principles. The scope of the disclosure is intended to cover all such embodiments that may fall within the scope of the appended claims, either literally or under the doctrine of equivalents.

It should be noted that the drawings set forth herein are not necessarily drawn to scale and, in some instances, proportions may have been exaggerated to more clearly depict certain features. Positional references such as “upper” and “lower” may be used in regard to certain components to aid in understanding, but are not to be construed as limiting since these components and the drive units in which they are housed may be oriented in various ways depending on the application in which they are used and may also be oriented in various ways during the assembly process. As stated above, this specification is intended to be taken as a whole and interpreted in accordance with the principles of the invention(s) as taught herein and understood by one of ordinary skill in the art.

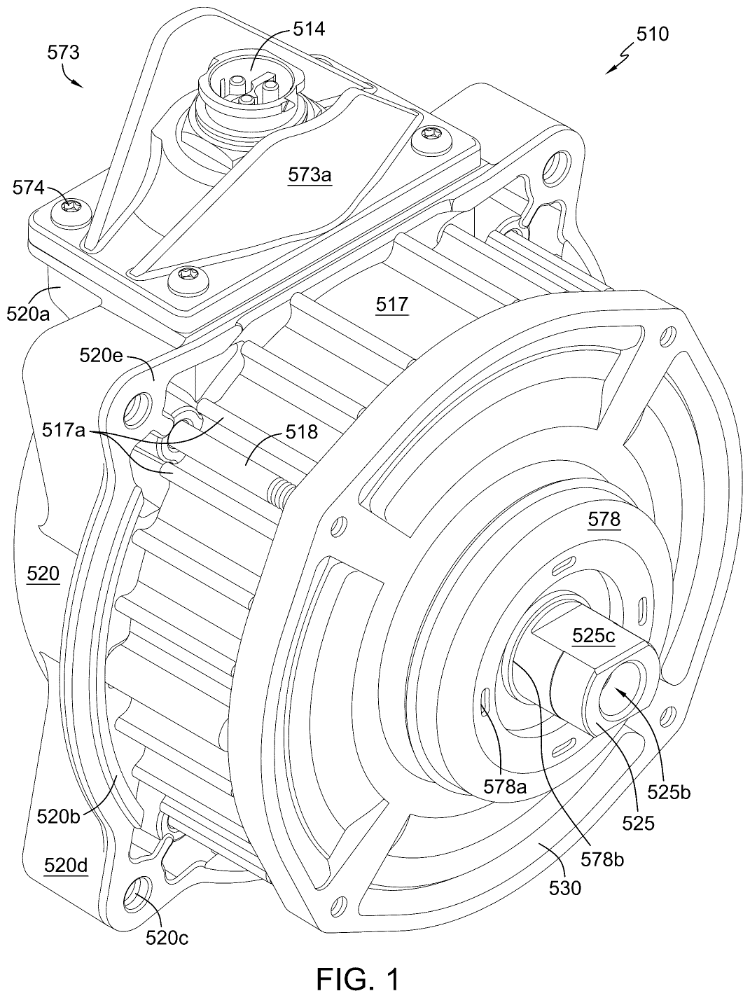

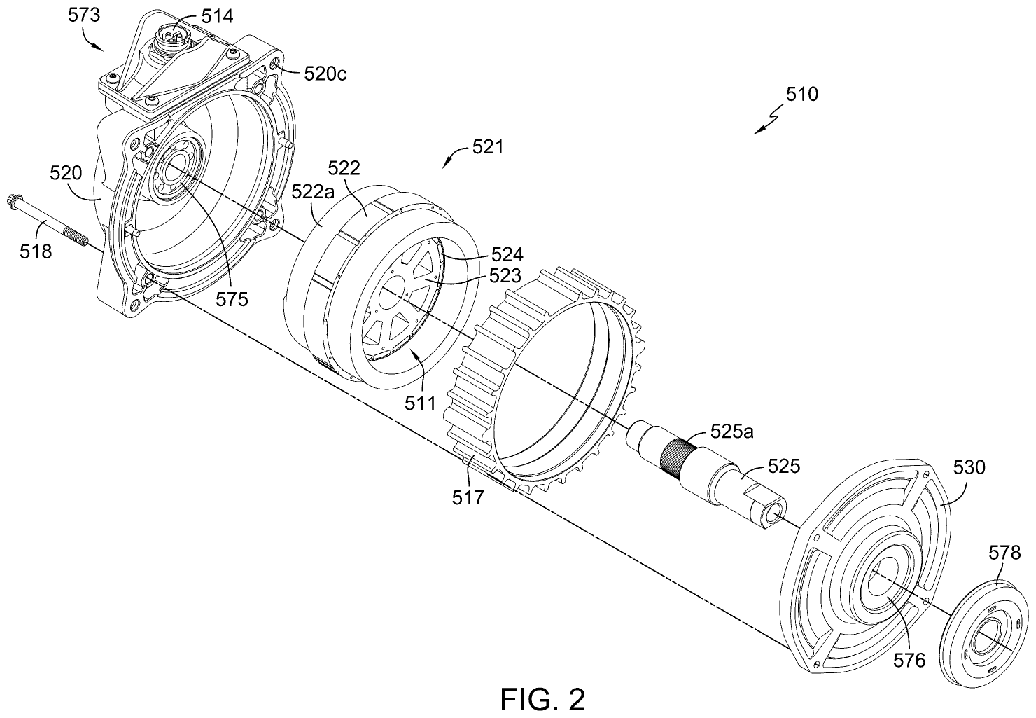

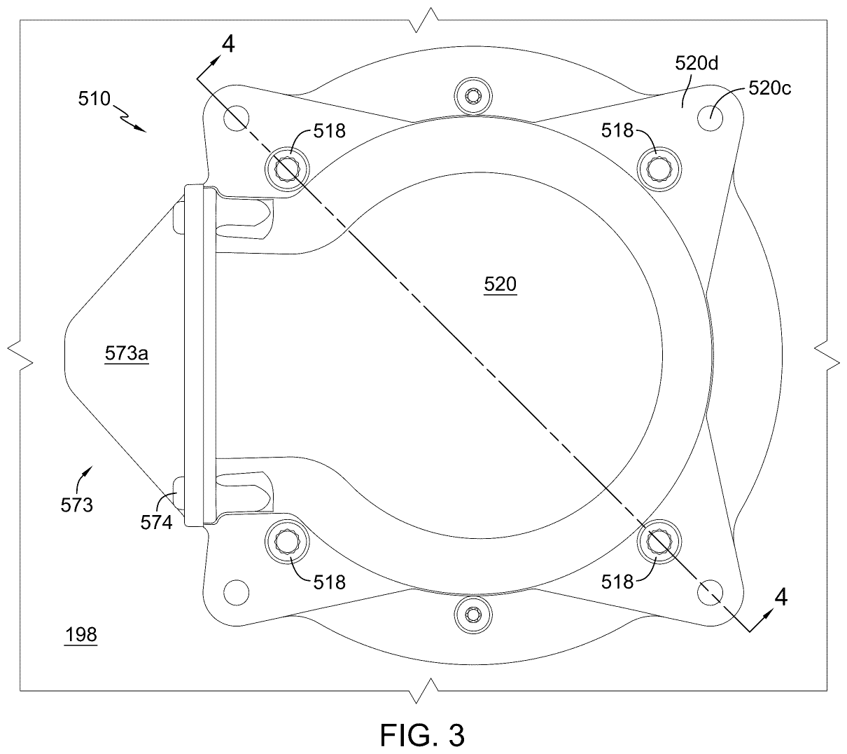

A first embodiment of an electric mid-mount motor assembly 510 is shown in FIGS. 1-4. As illustrated, a motor output cap 530 (lower housing) is joined to a motor end cap 520 (upper housing) via fasteners 518, with a motor stator housing 517 (middle housing) interposed between motor output cap 530 and motor end cap 520 to form an electric motor compartment 519 containing electric motor 521. Electric motor 521 comprises motor stator 522, motor windings 522a (approximate windings envelope shown), and a motor rotor assembly 511 that includes motor rotor 523 and magnets 524.

In the exemplary embodiment, motor stator housing 517 is a finned aluminum extrusion cut to a length dependent upon the number of laminations used to form the stator 522. The fins improve heat dissipation and provide stiffness but may not be required in some similar embodiments. For example, thickness of the cylindrical wall of the extrusion may be increased and/or material may be added at mounting lug locations, if needed. Fins may be omitted if structural requirements and motor performance requirements (such as running temperature) are met without fins. Also, other fin arrangements and profiles may be used. Referring to FIG. 1, each fastener 518 is flanked by fins 517a. This pair of fins 517a at each fastener 518 location may strengthen these joints by bearing against motor end cap 520 and motor output cap 530 to provide additional structural support when applying torque to fasteners 518.

A motor output shaft 525 extends through electric motor 521 and is supported by an upper bearing 575 located in motor end cap 520 and a sealed lower bearing 576 located in motor output cap 530. Splines 525a formed on motor output shaft 525 permanently secure rotor 523 of rotor assembly 511 to motor output shaft 525 via press-fit. A debris shield 578 may be installed adjacent to the lower bearing 576 to provide protection for this sealed bearing by preventing material (such as string, etc.) from wrapping around motor output shaft 525, binding against sealed lower bearing 576, and possibly causing bearing seal failure. Debris shield 578 may be press-fit onto motor output shaft 525, rotates with motor output shaft 525, and includes a plurality of drainage openings 578a. During component fabrication, debris shield 578 may be stamped such that a burr 578b or other retention feature is formed on lip 578c to help retain debris shield 578 on motor output shaft 525.

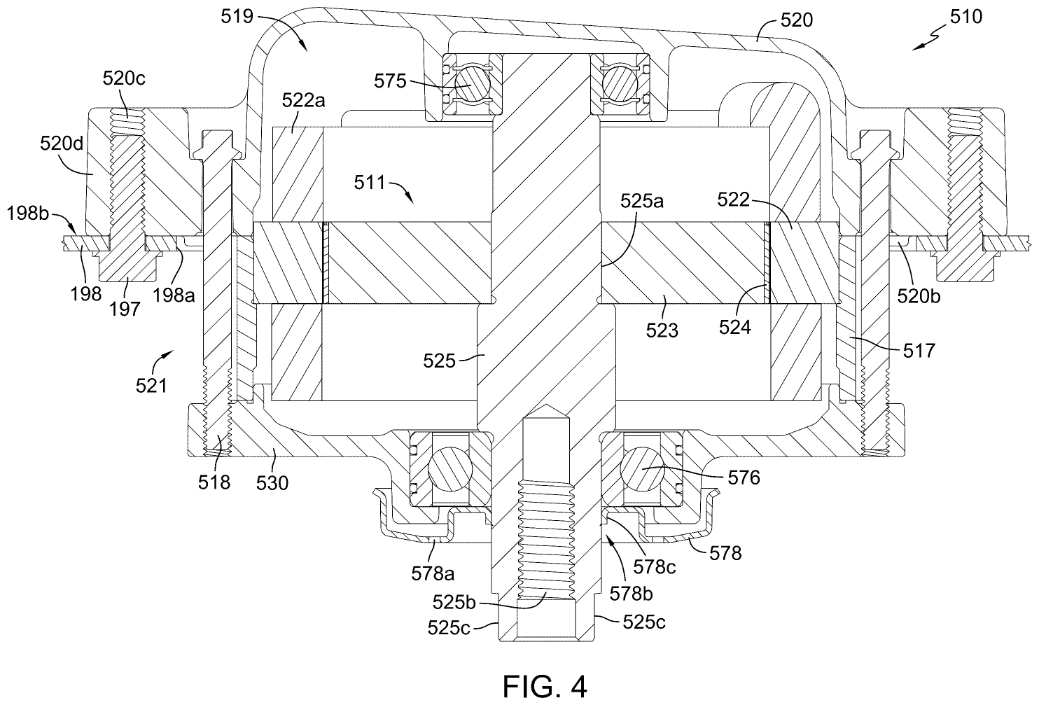

On a typical mowing deck assembly, each mowing blade is attached to a mower blade adapter (not shown) mounted on the motor output shaft of a deck motor or deck spindle. As shown in FIGS. 1 and 4, motor output shaft 525 may include adapter mounting features such as threaded bore 525b and flats 525c for securing one type of blade adapter by means of a mechanical fastener and mating flats formed on the blade adapter. Another common blade adapter interface that can be used in lieu of flats 525c is a keyway interface (not shown) that may allow shearing of a “key” in the event a mower blade strikes a solid object. A keyway interface may help prevent or reduce damage to electric deck motor assembly 510 in such an event.

An electrical connector 514 is attached or mounted to an electrical compartment cover 573. Compartment cover 573 includes connector guards 573a that extend beyond the sealed electrical connector 514 to protect it. Compartment cover 573 is secured by fasteners 574 to an electrical compartment 520a that may be integrally formed on the motor end cap 520. As illustrated, the environmentally sealed electrical connector 514 includes three motor power phase terminals.

Optionally, a Hall effect board (not shown) may be attached to motor end cap 520 adjacent to rotor assembly 511 as illustrated and described in more detail in commonly-owned U.S. Pat. No. 11,211,844, which is incorporated by reference herein in its entirety. When configured with such a Hall effect board (and with a proper substitute for electrical connector 514), electric motor assembly 510 can provide motor operational information (e.g., motor speed and temperature) to one or more electronic components of a vehicle control system.

Referring to FIGS. 1 and 4, motor end cap 520 provides a flat motor mounting surface 520e that extends around and radially beyond the outer circumference of stator housing 517 such that the stator housing 517 can be inserted through a deck motor opening 198a and the motor mounting surface 520e of motor end cap 520 will come to rest on a deck mounting surface 198b. The motor mounting surface 520e includes access to threaded mounting holes (bores) 520c to attach electric deck motor 510 to mowing deck 198 of vehicle 190 using fasteners 197. Fasteners 197 may be any appropriate type of locking fastener that ensures secure installation and precludes the possibility of fastener(s) 197 loosening during operation of deck motors 510. Pilot features 520b (ridges or protrusions) may be formed on motor end cap 520 as needed to help position each deck motor 510 in a conforming deck motor opening 198a during attachment of deck motor(s) 510 to a deck mounting surface 198b of mowing deck 198. The threaded mounting holes 520c are formed in a plurality of mounting lugs 520d formed on motor end cap 520 to enable fastening of the deck motor(s) 510 from the underside of mowing deck 198 along with attachment of mower blade(s) 199 for efficient assembly.

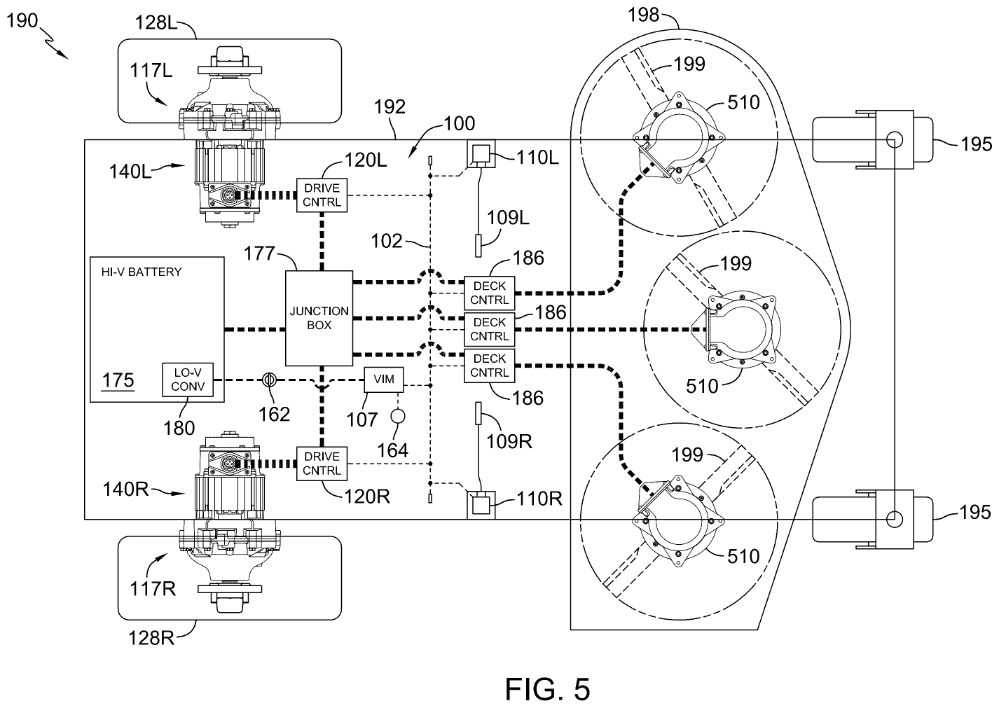

FIG. 5 depicts an electric zero turn-radius mowing vehicle 190 that incorporates one or more electric mid-mount deck motors 510 (three deck motors shown). Vehicle 190 includes a vehicle frame 192; a mowing deck 198; a pair of caster wheels 195; a CAN bus network 102; left and right operator controls such as lap bars 109L, 109R comprising left and right lap bar sensor modules 110L, 110R connected to the CAN bus; a vehicle integration module (VIM) 107; and a high voltage battery pack 175 (e.g., 48V) that can be connected to an external battery charging unit (not shown). Vehicle 190 also includes left and right electrically powered reduction drive units 117L, 117R that include electric motors 140L, 140R, respectively, that are connected to and controlled by left and right traction drive controllers 120L, 120R. The reduction drive units 117L, 117R (a.k.a. “traction drives” or “traction drive units”) separately drive left and right driven wheels 128L, 128R. Mowing deck 198 may feature one or more mower blades 199. Each mower blade 199 is powered by an electric deck motor 510 that is electrically connected to and independently controlled by a dedicated deck motor controller 186. Deck motor controllers 186 and drive motor controllers 120L, 120R are all connected to CAN bus 102 and receive high voltage DC power via junction box 177 connected to high voltage battery pack 175. Deck motor controllers 186 and drive motor controllers 120L, 120R convert incoming DC power to provide three-phase power output to the deck motors 510 and the electric drive motors 140L, 140R of reduction drive units 117L, 117R.

High voltage battery pack 175 includes a low voltage converter 180 (e.g., 12V). A vehicle power key switch 162 is electrically interposed between low voltage converter 180 and VIM 107. VIM 107 is connected to CAN Bus 102 and a deck power switch 164 (functioning as a power take-off switch) is connected to VIM 107 to enable and disable operation of the electric deck motors 510.

It will be understood that vehicle 190 may include other steering and drive input systems, such as a steering wheel and accelerator pedal, joystick, remote control, etc. It will also be understood that the basic drive and control system 100 illustrated in FIG. 5 comprises the electrical components and functions shown and may comprise additional electrical components and functions not shown (e.g., sensors, cameras, GPS receiver, Bluetooth module, inertial measurement unit, path controller, battery management system, remote control transceiver, safety interlock switches, operator interface displays, etc.). Drive and control system 100 and related components of vehicle 190 shown herein can also be used in an autonomous vehicle. It will further be understood that the electric mid-mount deck motor 510 disclosed herein may be used in other vehicle applications (e.g., without a CAN bus 102; with a vehicle controller in lieu of VIM 107; with a power take-off function other than mowing; in a mowing vehicle having a single electric transaxle and a single drive controller; in a hybrid vehicle having an electrically powered mowing deck).

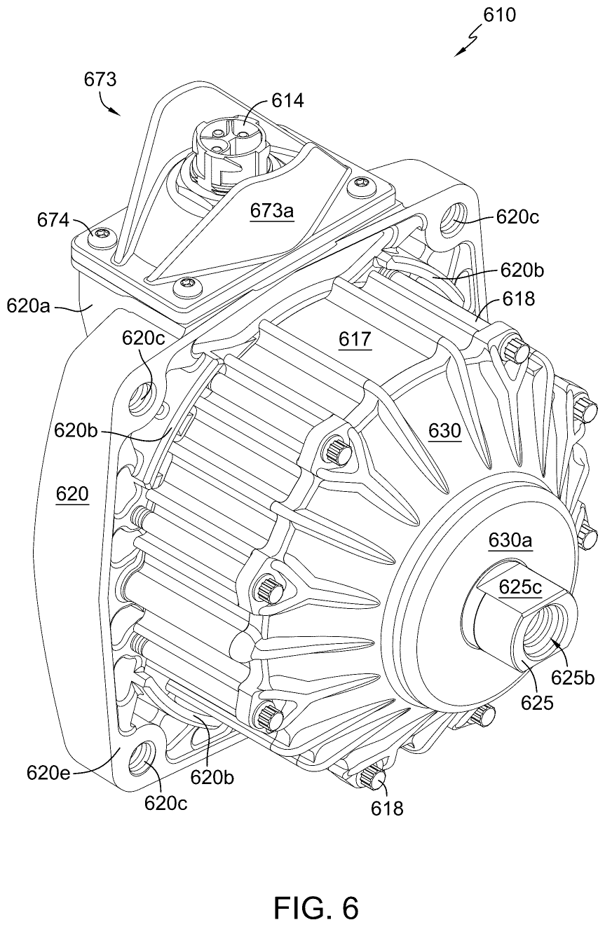

A second embodiment of an electric mid-mount motor assembly 610 is shown in FIGS. 6-8. Motor assembly 610 may be substituted for electric mid-mount motor assembly 510 in electric zero turn-radius mowing vehicle 190 and in other vehicle applications mentioned previously (e.g., without a CAN bus 102, etc.).

As illustrated, a motor output cap 630 (lower housing) is joined to a motor end cap 620 (upper housing) via fasteners 618, with a motor stator housing 617 (middle housing) interposed between motor output cap 630 and motor end cap 620 to form an electric motor compartment 619 containing electric motor 621. Electric motor 621 comprises a motor stator 622, motor windings 622a (approximate windings envelope shown), and a motor rotor assembly 611 that includes a motor rotor 623 and magnets 624. At the lower end of motor output shaft 625, for attachment of a mower blade 199, adapter mounting features such as lower threaded bore 625b and flats 625c are provided for securing a blade adapter by means of a mechanical fastener and mating flats formed on the blade adapter. As in the previously described motor assembly 510, a keyway adapter interface may be used with motor assembly 610 in lieu of flats 625c.

In this exemplary embodiment, motor stator housing 617 is a finned aluminum extrusion cut to a length dependent upon the number of laminations used to form the motor stator 622. As previously mentioned, the fins improve heat dissipation and provide stiffness but may not be required in some embodiments.

Electric motor output shaft 625 extends through electric motor 621 and motor output cap 630. Electric motor output shaft 625 is supported by an upper bearing 675 located in motor end cap 620 and by a sealed lower bearing 676 located in motor output cap 630. A bearing seal protection flange 630a is formed on motor output cap 630 and configured to fit closely around motor output shaft 625 to protect the sealed lower bearing 676. Thus, a debris shield such as debris shield 578 is not needed in this configuration. Splines 625a formed on motor output shaft 625 permanently secure the motor rotor assembly 611 to the motor output shaft 625 via press-fit.

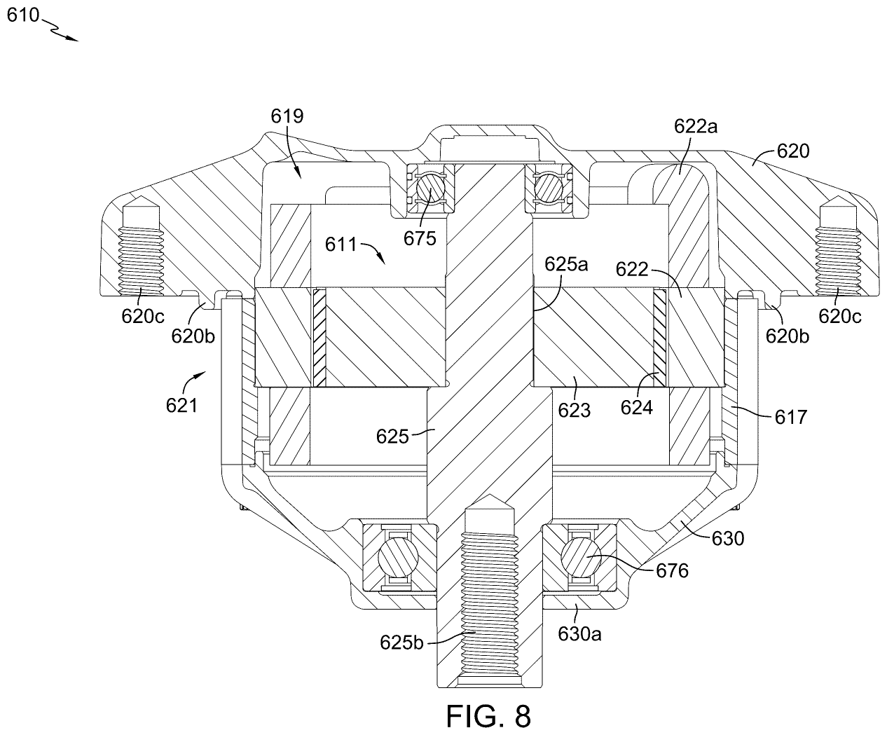

As shown in FIGS. 6 and 8, motor end cap 620 includes a flat motor mounting surface 620e that extends around and radially beyond the outer circumference of stator housing 617 such that the stator housing 617 can be inserted through a deck motor opening 198a and the motor mounting surface 620e of motor end cap 620 will come to rest on a deck mounting surface 198b. Mowing deck 198 (and corresponding deck mounting surface 198b and deck motor opening 198a) is not shown in FIGS. 6 and 8, but is the same as it appears in FIG. 4. The motor mounting surface 620e includes a plurality of downward-facing threaded mounting holes 620c to allow attachment of electric deck motor assembly 610 to mowing deck 198 of vehicle 190 from below the mowing deck (i.e., no access to the upper surface of the mowing deck is required to secure the electric motor assembly to the mowing deck).

Pilot features 620b (ridges or protrusions) may be formed on motor end cap 620 as needed to help position each deck motor 610 in a deck motor opening 198a during attachment of deck motor(s) 610 to a deck mounting surface 198b of mowing deck 198. A deck motor opening 198a may be configured as a round hole and pilot features 620b can help center a deck motor assembly 610 in the deck motor opening 198a to ease assembly. Alternatively, pilot features 620b may align with grooves (or other cut pattern or formed pilot receiving features) of a deck mounting surface 198b so as to aid in aligning threaded mounting holes 620c with corresponding holes in the mowing deck 198 to ease assembly. Although pilot features 620b are arranged symmetrically in the illustrated embodiment of deck motor assembly 610, these features could be arranged asymmetrically to allow clocked positioning of motor assembly 610 in order to, for example, position the electrical connector 614 in the correct direction for connection to a power source. As understood in the art and as used here, a design feature is “clocked” when its assembly position is set so as to orient it in a particular direction from a central axis. This direction may be altered where, for example, the design feature is fixed to the side of a component to be mounted, and there are multiple mounting holes located equidistant from a central axis through both the component to be mounted and the surface to which the component is to be mounted.

The threaded mounting holes 620c are formed on motor end cap 620 to enable mounting of the deck motor(s) 610 from the underside of mowing deck 198 along with attachment of mower blade(s) 199 for efficient assembly. The threaded mounting holes 620c do not penetrate the upper surface of motor end cap 620, thereby protecting the threads of motor mounting fasteners from corrosion and providing a smooth outer surface of motor end cap 620 that is easily cleaned and does not collect water, dirt and debris. Any holes that may penetrate the outer surface of motor end cap 620 can be sealed with plugs such as plugs 635 which cover assembly aid screws (not shown) that join motor stator housing 617 to motor end cap 620 prior to installing fasteners 618.

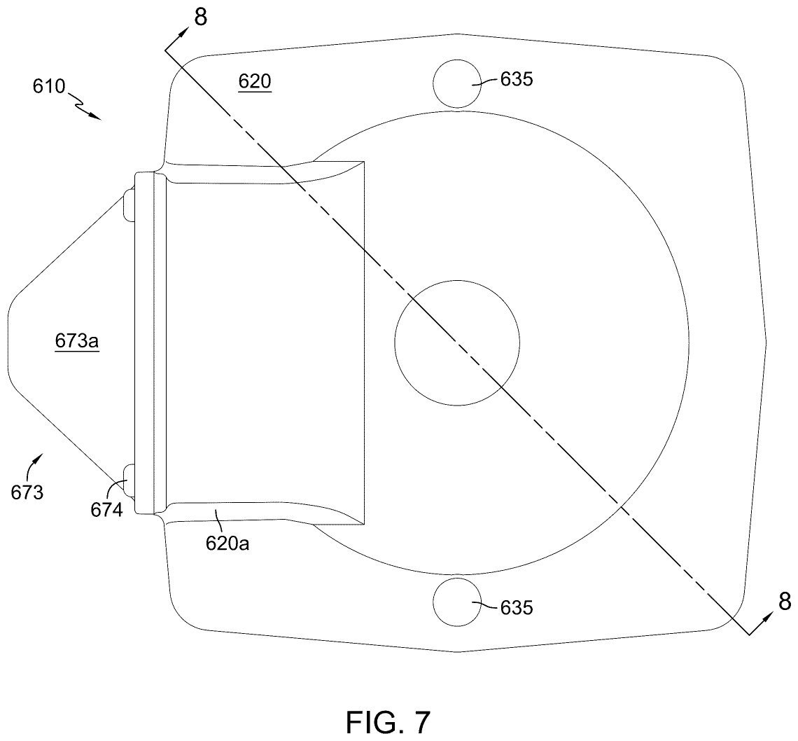

As shown in FIGS. 6 and 7, an environmentally sealed electrical connector 614 is attached or mounted to an electrical compartment cover 673. Compartment cover 673 includes connector guards 673a that extend beyond the sealed electrical connector 614 to protect it. Compartment cover 673 is secured by fasteners 674 to an electrical compartment 620a that may be integrally formed on the motor end cap 620.

Similar to the motor assembly 510 option, a Hall effect board (not shown) may be attached to motor end cap 620 adjacent to the rotor assembly 611 to provide motor operational information to one or more electronic components of the vehicle control system. Various examples of the inventions contemplated herein are set forth below.

Example 1. A method for assembling a lawn mower comprising the steps of: (1) positioning a mowing deck such that a top side of the mowing deck and a bottom side of the mowing deck are accessible; (2) starting from the top side of the mowing deck, inserting an electric motor assembly partially through an opening in the mowing deck until a motor output cap and a motor stator housing of the electric motor assembly extend through the opening and beyond the bottom side of the mowing deck, while a flat mounting surface of a motor end cap of the electric motor assembly comes to rest on the top side of the mowing deck; (3) aligning a first downward-facing threaded hole formed in the motor end cap with a first mounting hole of the mowing deck; and (4) from the bottom side of the mowing deck, threading a fastener into the first downward-facing threaded hole to secure the electric motor assembly to the mowing deck.

Example 2. The method of Example 1, further comprising the step of, from the bottom side of the mowing deck, securing a cutting blade to a motor output shaft of the electric motor assembly.

Example 3. The method of Examples 1 or 2, further comprising the step of aligning a second downward-facing threaded hole formed in the motor end cap with a second mounting hole of the mowing deck.

Example 4. The method of Example 3, wherein the first mounting hole of the mowing deck and the second mounting hole of the mowing deck are located an equal distance outside a circumference of the opening in the mowing deck.

Example 5. The method of Examples 3 or 4, wherein rotating the electric motor assembly such that the first downward-facing threaded hole formed in the motor end cap is aligned with the second mounting hole of the mowing deck would clock an electrical connector fitted to a side of the motor end cap in a different direction.

Example 6. The method of any of Examples 1-5, wherein the aligning step further comprises aligning one or more pilot features formed in the motor end cap with one or more grooves formed on the top side of the mowing deck.

Example 7. The method of any of Examples 1-6, wherein the downward-facing threaded holes do not extend fully through the motor end cap, such that an upper surface of the motor end cap is substantially smooth.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the invention which is to be given the full breadth of the appended claims and any equivalent thereof.

What is claimed is:

1. An electric motor assembly comprising:
a motor end cap forming an upper housing, the motor end cap comprising a flat motor mounting surface for mounting the electric motor assembly to a deck mounting surface of a utility vehicle;
a motor output cap forming a lower housing and connected to the motor end cap by a plurality of fasteners; and
a motor stator housing interposed between the motor end cap and motor output cap to form an electric motor compartment wherein an electric motor comprising a motor stator, motor windings, and a motor rotor assembly are located;
wherein the flat motor mounting surface of the motor end cap extends around and radially beyond an outer circumference of the motor stator housing.

2. The electric motor assembly of claim 1, wherein the flat motor mounting surface of the motor end cap comprises a plurality of downward-facing threaded holes for use in attaching the electric motor assembly to the deck mounting surface from an underside of the deck mounting surface.

3. The electric motor assembly of claim 2, wherein the downward-facing threaded holes do not extend fully through the motor end cap, such that an upper surface of the motor end cap is substantially smooth.

4. The electric motor assembly of claim 2, wherein the motor end cap further comprises one or more pilot features for use in aligning the downward-facing threaded holes with corresponding mounting holes in the deck mounting surface.

5. The electric motor assembly of claim 4, further comprising an electrical connector extending from a side of the motor end cap, and wherein each of the one or more pilot features corresponds with one or more grooves in the deck mounting surface such that the orientation of the electrical connector may be clocked.

6. The electric motor assembly of claim 1, further comprising a motor output shaft supported on a first end by an upper bearing disposed in the motor end cap and supported on a second end by a sealed lower bearing disposed in the motor output cap.

7. The electric motor assembly of claim 6, wherein the motor output cap comprises a bearing seal protection flange that fits closely around an outer circumference of the motor output shaft to protect the sealed lower bearing from debris.

8. The electric motor assembly of claim 1, wherein the stator housing comprises a plurality of fins around its outer circumference, and wherein each of the plurality of fasteners is flanked on either side by one of the plurality of fins.

9. The electric motor assembly of claim 1, wherein the stator housing and the motor output cap are configured to fit through a deck motor opening of the deck mounting surface to be exposed to airflow beneath the deck mounting surface.

10. A utility vehicle comprising:
a deck mounting surface comprising at least one deck motor opening; and
an electric motor assembly comprising:
a motor end cap forming an upper housing, the motor end cap comprising a flat motor mounting surface for mounting the electric motor assembly to the deck mounting surface;
a motor output cap forming a lower housing and connected to the motor end cap by a plurality of fasteners; and
a motor stator housing interposed between the motor end cap and motor output cap to form an electric motor compartment wherein an electric motor comprising a motor stator, motor windings, and a motor rotor assembly are located;
wherein, when the flat motor mounting surface of the motor end cap is mounted to the deck mounting surface, the motor output cap and the motor stator housing extend through the at least one deck motor opening.

11. The utility vehicle of claim 10, further comprising:
a motor output shaft supported on a first end by an upper bearing disposed in the motor end cap and supported on a second end by a sealed lower bearing disposed in the motor output cap; and
a mowing blade rotatably connected to the motor output shaft;
wherein rotation of the mowing blade creates an airflow to cool the motor output cap and the motor stator housing.

12. The utility vehicle of claim 11, wherein the motor output cap comprises a bearing seal protection flange that fits closely around an outer circumference of the motor output shaft to protect the sealed lower bearing from debris.

13. The utility vehicle of claim 11, wherein a debris shield is fitted to the motor output shaft and positioned adjacent to the sealed lower bearing to protect the sealed lower bearing.

14. The utility vehicle of claim 13, wherein the debris shield comprises a lip that conforms to an exterior shape of the motor output shaft, the lip having at least one retention feature for permanently retaining the debris shield on the motor output shaft after assembly.

15. The utility vehicle of claim 13, wherein the debris shield has a plurality of drainage openings formed therein.

16. The utility vehicle of claim 10, wherein the motor end cap comprises an electrical compartment and presents an electrical connector protected by a plurality of connector guards.

17. The utility vehicle of claim 10, wherein the flat motor mounting surface of the motor end cap comprises a plurality of downward-facing threaded holes for securing the electric motor assembly to the deck mounting surface.

18. The utility vehicle of claim 17, wherein the deck mounting surface further comprises at least one pilot receiving feature, and wherein the motor end cap further comprises at least one pilot feature configured to mate with the at least one pilot receiving feature, thereby aligning the plurality of downward-facing threaded holes with a plurality of fastener holes arranged around the at least one deck motor opening in the deck mounting surface.

19. The utility vehicle of claim 17, wherein the plurality of downward-facing threaded holes does not extend fully through the motor end cap, such that an upper surface of the motor end cap is substantially smooth.

20. The utility vehicle of claim 10, wherein the stator housing comprises a plurality of fins around its outer circumference, and wherein each of the plurality of fasteners is flanked on either side by one of the plurality of fins.

21. The utility vehicle of claim 10, wherein the at least one deck motor opening has a perimeter that is not recessed from the deck mounting surface.
